(19) United States
(12) Patent Application Publication
(10) Pub. No.: US 2006/0225778 A1
(43) Pub. Date: Oct. 12, 2006

(54) Photovoltaic module

(76) Inventors: Christoph Brabec, Linz (AT); Markus Scharber, Linz (AT)

Correspondence Address: FISH & RICHARDSON PC, P.O. BOX 1022, MINNEAPOLIS, MN, 55440-1022, US

(21) Appl. No.: 11/377,953

(22) Filed: Mar. 17, 2006

Related U.S. Application Data
(60) Provisional application No. 60/664,168, filed on Mar. 21, 2005.

(51) Int. Cl. H02N 6/00

(52) U.S. Cl. 136/244

(57) ABSTRACT

Photovoltaic modules, as well as related systems, methods and components are disclosed.

### CROSS REFERENCE TO RELATED APPLICATION

Pursuant to 35 U.S.C. § 119(e), this application claims priority to U.S. Provisional Application Ser. No. 60/664,168, filed Mar. 21, 2005, the contents of which are hereby incorporated by reference.

### TECHNICAL FIELD

This disclosure relates to photovoltaic modules, as well as related systems, methods and components.

### BACKGROUND

Photovoltaic cells, sometimes called solar cells, can convert light, such as sunlight, into electrical energy. A typical photovoltaic cell includes a layer of a photoactive material disposed between a cathode and an anode. When incident light excites the photoactive material, electrons are released. The released electrons are captured in the form of electrical energy within the electric circuit created between the cathode and the anode.

In one type of photovoltaic cell, commonly called a dye-sensitized solar cell (DSSC), the photoactive material typically includes a semiconductor material (such as titania) and a photosensitizing agent (such as a dye). In general, the dye is capable of absorbing photons within a wavelength range of operation (e.g., within the solar spectrum).

In another type of photovoltaic cell, commonly referred to as a polymer thin film cell, the photoactive material used generally has two components, an electron acceptor and an electron donor. The electron donor can be a p-type polymeric conductor material, such as, poly(phenylene vinylene) or poly(3-hexylthiophene). The electron acceptor can be a nanoparticulate material, such as, a derivative of fullerene (e.g., 1-(3-methoxy carbonyl)-propyl-1-1-phenyl-(6,6) C61, known as PCBM).

Photovoltaic cells can be electrically connected in series and/or in parallel to create a photovoltaic module. Typically, two photovoltaic cells are connected in parallel by electrically connecting the cathode of one cell with the cathode of the other cell, and the anode of one cell with the anode of the other cell. In general, two photovoltaic cells are connected in series by electrically connecting the anode of one cell with the cathode of the other cell.

### SUMMARY

This disclosure relates to photovoltaic modules, as well as related systems, methods and components.

In one aspect, this invention features a photovoltaic module that includes a first photovoltaic cell having a first photoactive material and a second photovoltaic cell having a second photoactive material. The first photoactive material has a first maximum absorption wavelength. The second photoactive material has a second maximum absorption wavelength different from the first maximum absorption wavelength. The first and second photovoltaic cells are electrically connected and form an angle in the range from about 5° to about 175°.

In another aspect, this invention features a photovoltaic module that includes a first photovoltaic cell having a first photoactive material and a second photovoltaic cell having a second photoactive material. The first photoactive material includes a first electron acceptor material selected from the group consisting of fullerenes, inorganic nanoparticles, oxadiazoles, discotic liquid crystals, carbon nanorods, inorganic nanorods, polymers containing CN groups, polymers containing CF₃ groups, and combinations thereof. The first and second photovoltaic cells are electrically connected and form an angle in the range from about 5° to about 175°.

In still another aspect, this invention features a photovoltaic module that includes a first photovoltaic cell having a flexible substrate and a second photovoltaic cell. The first and second photovoltaic cells are electrically connected and form an angle in the range from about 5° to about 175°.

In still another aspect, the invention features a photovoltaic module that includes a first photovoltaic cell and a second photovoltaic cell. The first and second photovoltaic cells are electrically connected and form a parabolic shape.

Embodiments can include one or more of the following features.

The angle can be at least about 10° (e.g., at least about 30°, at least about 50°, at least about 70°, at least about 90°, at least about 110°, at least about 130°, at least about 150°, or at least about 170°) and/or at most about 160° (e.g., at most about 140°, at most about 120°, at most about 100°, at most about 80°, at most about 60°, at most about 40°, or at most about 200).

The first maximum absorption wavelength can be at least about 25 nm (e.g., at least about 50 nm, at least about 100 nm, at least about 150 nm, at least about 200 nm, at least about 250 nm, or at least about 300 nm) different from the second maximum absorption wavelength. In some embodiments, the first maximum absorption wavelength is identical to the second maximum absorption wavelength.

The first and second photoactive materials can include first and electron acceptor materials, respectively. Each of the first and second electron acceptor materials can independently include a material selected from the group consisting of fullerenes, inorganic nanoparticles, oxadiazoles, discotic liquid crystals, carbon nanorods, inorganic nanorods, polymers containing CN groups, polymers containing CF₃ groups, and combinations thereof. The first and second electron acceptor materials can be identical or different.

The fullerene can be a substituted fullerene (e.g., PCBM).

The inorganic nanoparticles can include a compound selected from the group consisting of titanium oxide, zirconium oxide, zinc oxide, tungsten oxide, niobium oxide, lanthanum oxide, tin oxide, terbium oxide, tantalum oxide, indium phosphide, cadmium selenide, lead sulphide, and combinations thereof. In some embodiments, at least one of the first and second photoactive materials can include dye-sensitized interconnected inorganic nanoparticles.

The first and second photoactive materials can further include first and second electron donor materials, respectively. Each of the first and second electron donor materials can independently include a polymer selected from the group consisting of polyacetylenes, polyanilines, polyphenylenes, poly(p-phenylene vinylene)s, polythienylvinylenes, polythiophenes, polyporphyrins, porphyrinic macrocycles, polymetallocenes, polyisothianaphthalenes, polyphthalocyanines, discotic liquid crystal polymers, and combinations thereof. The first and second electron donor materials can be identical or different.

At least one of the first and second photoactive materials can further include a dye. In some embodiments, the dye can be a compound selected from the group consisting of cyanines, merocyanines, phthalocyanines, pyrroles and xanthines, and combinations thereof.

Each of the first and second photovoltaic cells can include two electrodes. In some embodiments, at least one of the electrodes can include ITO, tin oxide, or fluorine-doped tin oxide.

The photovoltaic module can include an electrode shared by the first and second photovoltaic cells.

At least one of the first and second photovoltaic cells can include a flexible substrate. In some embodiments, the flexible substrate can be prepared from a polymer selected from a group consisting of polyethylene naphthalates, polyethylene terephthalates, polyethyelenes, polypropylenes, polyamides, polymethyl methacrylate, polycarbonates, polyurethanes, or combinations thereof.

Embodiments can provide one or more of the following advantages.

In some embodiments, incident light not absorbed by the one of the two photovoltaic cells can be reflected to the other photovoltaic cell and subsequently absorbed by that cell, thereby maximizing the absorption of the incident light by the photovoltaic module. As a result, such a photovoltaic module has an improved efficiency.

In certain embodiments, the two photoactive materials in the two photovoltaic cells can have different maximum absorption wavelength. Thus, incident light at a wavelength not absorbed by one of the two photovoltaic cells can be absorbed by the other photovoltaic cell, thereby maximizing the absorption of the incident light.

In certain embodiments, the photovoltaic module can be folded into a compact form, which can be easily stored or carried. During operation, the photovoltaic module can then be unfolded to expose the photovoltaic cells to the incident light (e.g., sunlight).

In certain embodiments, the photovoltaic module can include a flexible substrate, which can facilitate re-forming and/or re-shaping the photovoltaic module.

Other features and advantages of the invention will be apparent from the description, drawings, and claims.

### DESCRIPTION OF DRAWINGS

FIG. 1 is a cross-sectional view of an unfolded photovoltaic module.

FIG. 2 is a cross-sectional view of a folded photovoltaic module.

FIG. 3 is a cross-sectional view of a DSSC.

FIG. 4 is a cross-sectional view of a polymer photovoltaic cell.

FIG. 5 is a cross-sectional view of a photovoltaic module having parabolic portions.

Like reference symbols in the various drawings indicate like elements.

### DETAILED DESCRIPTION

In general, the description relates to photovoltaic modules having two or more electrically and/or mechanically connected photovoltaic cells. Embodiments of such modules are described below.

In some embodiments, the efficiency of a photovoltaic module can be at least about 80% (e.g., at least about 85%, at least about 90%, at least about 95%, at least about 98%) of the efficiency of one or more of the photovoltaic cells contained in the photovoltaic module.

As referred to herein, the efficiency of a photovoltaic cell is measured as follows. The photovoltaic cell is exposed to an A.M. 1.5 (100 mW per square cm) light source (Oriel Solar Simulator) for 30 seconds. The current generated within the photovoltaic cell is measured and plotted against voltage to determine the efficiency of the photovoltaic cell.

As used herein, the efficiency of a photovoltaic module is measured as follows. The photovoltaic module is exposed to an A.M. 1.5 (100 mW per square cm) light source (Oriel Solar Simulator) for 30 seconds. The current generated within the photovoltaic module is measured and plotted against voltage to determine the efficiency of the photovoltaic module.

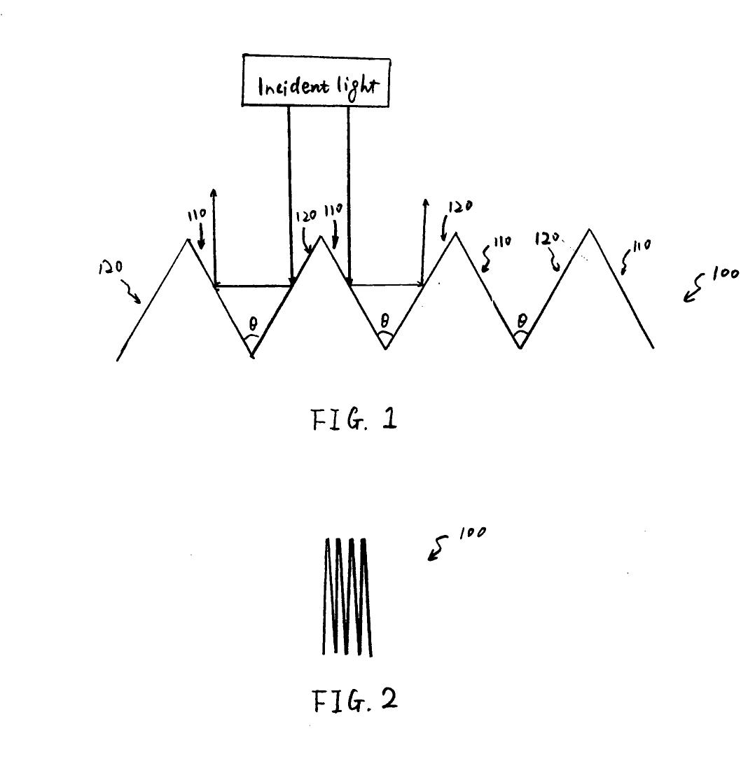

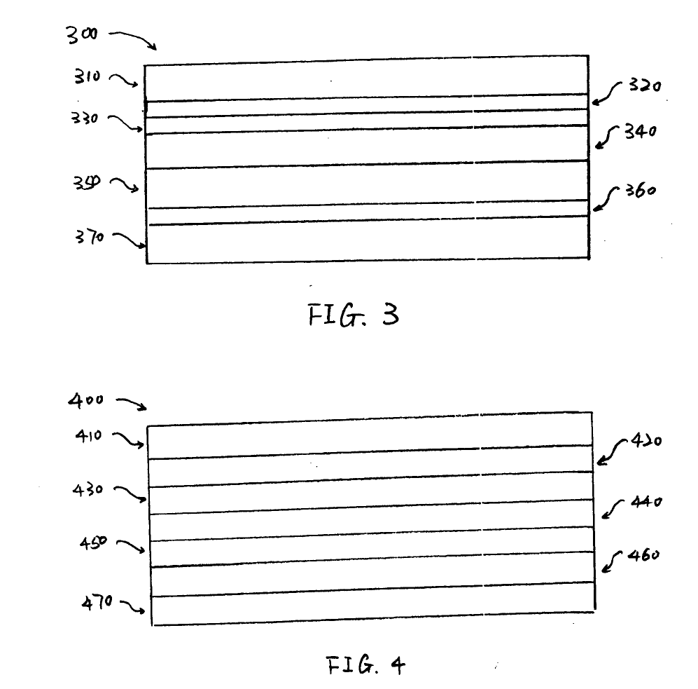

FIG. 1 shows a cross-sectional view of an unfolded photovoltaic module 100 that includes a plurality of photovoltaic cells 110 and 120. Each pair of photovoltaic cells 110 and 120 form a V-shaped portion having an angle θ. The angle θ generally allows the incident light not absorbed by one photovoltaic cell on one side of the V-shaped portion be reflected to the photovoltaic cell on the other side of the same V-shaped portion. In some embodiments, the angle θ is at least about 5° (e.g., at least about 10°, at least about 30°, at least about 50°, at least about 70°, at least about 90°, at least about 110°, at least about 130°, at least about 150°, or at least about 170°) and/or at most about 175° (e.g., at most about 160°, at most about 140°, at most about 120°, at most about 100°, at most about 80°, at most about 60°, at most about 40°, or at most about 20°). In some embodiments, the angle θ is about 60°. In certain embodiments, an angle θ of one V-shaped portion can be different from an angle θ of another V-shaped portion. In certain embodiments, an angle θ of one V-shaped portion can be the same as an angle θ of another V-shaped portion. When photovoltaic module 100 is not used, it can be folded into a compact form, which can be easily stored or carried. FIG. 2 shows a cross-sectional view of a folded photovoltaic module 100.

In general, each of photovoltaic cells 110 and 120 contains a photoactive material. In some embodiments, the photoactive material in photovoltaic cells 110 has a maximum absorption wavelength that is the same as that of the photoactive material in photovoltaic cells 120. In certain embodiments, the photoactive material in photovoltaic cells 110 has a maximum absorption wavelength at least 25 nm (e.g., at least about 50 nm, at least about 100 nm, at least about 150 nm, at least about 200 nm, at least about 250 nm, at least about 300 nm, at least about 350 nm, at least about 400 nm, or at least about 450 nm) different from that of the photoactive material in photovoltaic cells 120.

In some embodiments, each of photovoltaic cells 110 and 120 contains two electrodes. The electrodes in a photovoltaic cell can be identical or different. In certain embodiments, at least one of the electrode in photovoltaic cell 110 or 120 can be formed of a transparent electrically conductive material. Examples of such materials include certain metal oxides, such as indium tin oxide (ITO), tin oxide, a fluorine-doped tin oxide, and zinc-oxide. In some embodiments, at least one of the electrodes in photovoltaic cell 110 or 120 can be formed of a metal mesh or a metal foil. Suitable metals that can be used to form the mesh or foil include palladium, titanium, platinum, stainless steel and alloys thereof. In certain embodiments, at least one of the electrodes of a photovoltaic cell can be formed of a material different from that of at least one of the electrodes of a different photovoltaic cell. In some embodiments, photovoltaic cell 110 can share an electrode with an photovoltaic cell 120. For example, photovoltaic cells 110 and 120 can share an electrode located at the bottom of each cell (i.e., between a substrate and other components of photovoltaic cell 110 or 120). Such photovoltaic module can be prepared by depositing a shared electrode on a substrate, and then depositing other components of photovoltaic cell 110 or 120 on the shared electrode.

In some embodiments, each of photovoltaic cells 110 and 120 can contain an anti-reflective (or anti-reflection; AR) coating on its surface. Without wishing to be bound by theory, it is believed that such an AR coating on a photovoltaic cell can minimize the amount of incident light that is reflected on the surface of the photovoltaic cell, thereby increasing the amount of the incident light available for absorption by the photovoltaic cell.

In some embodiments, an AR coating can consist of a single quarter-wave layer of a transparent material, whose refractive index is the square root of the substrate's refractive index. Such an AR coating can give zero reflectance at the center wavelength and gradually increased reflectance for wavelengths in a broad band around the center. An example of a substrate includes optical glass (e.g., crown glass or bare glass). In certain embodiments, the substrate can have a refractive index at least about 1.3 (e.g., at least about 1.4, at least about 1.5, at least about 1.6, at least about 1.7, at least about 1.8, or at least about 1.9). In some embodiments, a single-layer AR coating can be formed of magnesium fluoride (MgF₂), which has a refractive index of 1.38. A MgF₂ coating typically has about 1% reflectance on crown glass and about 4% reflectance on bare glass. In general, when a MgF₂ coating is used for a wavelength in the middle of the visible spectrum, it gives good antireflection over the entire visible spectrum.

In some embodiments, an AR coating is formed of transparent thin film structures with alternating layers of contrasting refractive index. Layer thicknesses can be chosen to produce destructive interference in the beams reflected from the interfaces, and constructive interference in the corresponding transmitted beams. This makes the structure's performance change with the wavelength and incident angle (as in diffraction). Thus, such a coating is typically designed for a particular wavelength range (e.g., in the IR, visible or UV region). In certain embodiments, an AR coating can contain alternative layers of a low-index material (e.g., silica) and a high-index material ([please provide us with one or more suitable high-index materials.]). Such an AR coating can have reflectance as low as 0.1% at a single wavelength. In some embodiments, an AR coating can have unique characteristics, such as near-zero reflectance at multiple wavelengths, or optimum performance at an incidence angles other than 0°.

In some embodiments, each of photovoltaic cells 110 and 120 is a DSSC or a polymer photovoltaic cell. If desired, different photovoltaic cells in photovoltaic module 100 can be of different types of cells. For example, in a V-shaped portion of photovoltaic module 100, one photovoltaic cell can be a DSSC and the other can be a polymer photovoltaic cell.

In some embodiments, photovoltaic cell 100 can be manufactured by first preparing a plurality of photovoltaic cells on a flexible substrate using a roll-to-roll process and then partial slitting the flexible substrate to form to a plurality of V-shaped portions, each of which contains two photovoltaic cells. Examples of roll-to-roll processes are disclosed in co-pending and commonly owned U.S. Ser. No. 11/134,921, U.S. Ser. No. 10/395,823, and U.S. Ser. No. 11/127,439, which are hereby incorporated by reference. Examples of slitting methods are disclosed in co-pending and commonly owned U.S. Ser. No. 10/351,250, which is hereby incorporated by reference.

DSSCs

In some embodiments, a photovoltaic cell 110 or 120 shown in FIG. 1 is a DSSC. FIG. 3 is a cross-sectional view of a DSSC 300 including substrates 310 and 370, electrically conductive layers (electrodes) 320 and 360, a catalyst layer 330, a charge carrier layer 340, and a photoactive layer 350.

Photoactive layer 350 generally includes one or more dyes and a semiconductor material associated with the dye.

Examples of dyes include black dyes (e.g., tris(isothiocyanato)-ruthenium (II)-2,2′:6′,2″-terpyridine-4,4′,4″-tricarboxylic acid, tris-tetrabutylammonium salt), orange dyes (e.g., tris(2,2′-bipyridyl-4,4′-dicarboxylato) ruthenium (II) dichloride, purple dyes (e.g., cis-bis(isothiocyanato)bis-(2,2′-bipyridyl-4,4′-dicarboxylato)-ruthenium (II)), red dyes (e.g., an eosin), green dyes (e.g., a merocyanine) and blue dyes (e.g., a cyanine). Examples of additional dyes include anthocyanines, porphyrins, phthalocyanines, squarates, and certain metal-containing dyes.

In some embodiments, photoactive layer 350 can include multiple different dyes that form a pattern. Examples of patterns include camouflage patterns, roof tile patterns and shingle patterns. In some embodiments, the pattern can define the pattern of the housing a portable electronic device (e.g., a laptop computer, a cell phone). In certain embodiments, the pattern provided by the photovoltaic cell can define the pattern on the body of an automobile. Patterned photovoltaic cells are disclosed, for example, in co-pending and commonly owned U.S. Ser. No. 11/311,805, which is hereby incorporated by reference.

Examples of semiconductor materials include materials having the formula MₓO_{y}, where M can be, for example, titanium, zirconium, zinc, tungsten, niobium, lanthanum, tantalum, terbium, or tin, and x and y are integers greater than zero. Other suitable materials include phosphides, sulfides, selenides, tellurides, niobates, and oxides of titanium, zirconium, tungsten, niobium, lanthanum, tantalum, terbium, tin, indium, lead, potassium, or combinations thereof. For example, TiO₂, SrTiO₃, CaTiO₃, ZrO₂, WO₃, La₂O₃, Nb₂O₅, SnO₂, sodium titanate, indium phosphide, lead sulphide, cadmium selenide (CdSe), cadmium sulphides, and potassium niobate may be suitable materials.

Typically, the semiconductor material contained within photoactive layer 350 is in the form of nanoparticles. In some embodiments, the nanoparticles have an average size between about two nm and about 100 nm (e.g., between about 10 nm and 40 nm, such as about 20 nm). Examples of nanoparticle semiconductor materials are disclosed, for example, in co-pending and commonly owned U.S. Ser. No. 10/351,249, which is hereby incorporated by reference.

The nanoparticles can be interconnected, for example, by high temperature sintering, or by a reactive linking agent.

In certain embodiments, the linking agent can be a non-polymeric compound. The linking agent can exhibit similar electronic conductivity as the semiconductor particles. For example, for TiO₂ particles, the agent can include Ti—O bonds, such as those present in titanium alkoxides. Without wishing to be bound by theory, it is believed that titanium tetraalkoxide particles can react with each other, with TiO₂ particles, and with a conductive coating (not shown) on a substrate, to form titanium oxide bridges that connect the particles with each other and with the conductive coating. As a result, the cross-linking agent enhances the stability and integrity of the semiconductor layer. The cross-linking agent can include, for example, an organometallic species such as a metal alkoxide, a metal acetate, or a metal halide. In some embodiments, the cross-linking agent can include a different metal than the metal in the semiconductor. In an exemplary cross-linking step, a cross-linking agent solution is prepared by mixing a sol-gel precursor agent, e.g., a titanium tetra-alkoxide such as titanium tetrabutoxide, with a solvent, such as ethanol, propanol, butanol, or higher primary, secondary, or tertiary alcohols, in a weight ratio of 0-100%, e.g., about 5 to about 25%, or about 20%. Generally, the solvent can be any material that is stable with respect to the precursor agent, e.g., does not react with the agent to form metal oxides (e.g. TiO₂). The solvent preferably is substantially free of water, which can cause precipitation of TiO₂. Such linking agents are disclosed, for example, in published U.S. Patent Application 2003-0056821, which is hereby incorporated by reference.

In some embodiments, a linking agent can be a polymeric linking agent, such as poly(n-butyl titanate). Examples of polymeric linking agents are disclosed, for example, in co-pending and commonly owned U.S. Ser. No. 10/350,913, which is hereby incorporated by reference.

Linking agents can allow for the fabrication of an interconnected nanoparticle layer at relatively low temperatures (e.g., less than about 300° C.) and in some embodiments at room temperature. The relatively low temperature interconnection process may be amenable to continuous (e.g., roll-to-roll) manufacturing processes using polymer substrates.

The interconnected nanoparticles are generally photosensitized by the dye(s). The dyes facilitate conversion of incident light into electricity to produce the desired photovoltaic effect. It is believed that a dye absorbs incident light resulting in the excitation of electrons in the dye. The energy of the excited electrons is then transferred from the excitation levels of the dye into a conduction band of the interconnected nanoparticles. This electron transfer results in an effective separation of charge and the desired photovoltaic effect. Accordingly, the electrons in the conduction band of the interconnected nanoparticles are made available to drive an external load.

The dye(s) can be sorbed (e.g., chemisorbed and/or physisorbed) on the nanoparticles. A dye can be selected, for example, based on its ability to absorb photons in a wavelength range of operation (e.g., within the visible spectrum), its ability to produce free electrons (or electron holes) in a conduction band of the nanoparticles, its effectiveness in complexing with or sorbing to the nanoparticles, and/or its color.

In some embodiments, photoactive layer 350 can further include one or more co-sensitizers that adsorb with a sensitizing dye to the surface of an interconnected semiconductor oxide nanoparticle material, which can increase the efficiency of a DSSC (e.g., by improving charge transfer efficiency and/or reducing back transfer of electrons from the interconnected semiconductor oxide nanoparticle material to the sensitizing dye). The sensitizing dye and the co-sensitizer may be added together or separately when forming the photosensitized interconnected nanoparticle material. The co-sensitizer can donate electrons to an acceptor to form stable cation radicals, which can enhance the efficiency of charge transfer from the sensitizing dye to the semiconductor oxide nanoparticle material and/or can reduce back electron transfer to the sensitizing dye or co-sensitizer. The co-sensitizer can include (1) conjugation of the free electron pair on a nitrogen atom with the hybridized orbitals of the aromatic rings to which the nitrogen atom is bonded and, subsequent to electron transfer, the resulting resonance stabilization of the cation radicals by these hybridized orbitals; and/or (2) a coordinating group, such as a carboxy or a phosphate, the function of which is to anchor the co-sensitizer to the semiconductor oxide. Examples of suitable co-sensitizers include aromatic amines (e.g., triphenylamine and its derivatives), carbazoles, and other fused-ring analogues. Examples of photoactive layers including co-sensitizers are disclosed in co-pending and commonly owned U.S. Ser. No. 10/350,919, which is hereby incorporated by reference.

In some embodiments, photoactive layer 350 can further include macroparticles of the semiconductor material, where at least some of the semiconductor macroparticles are chemically bonded to each other, and at least some of the semiconductor nanoparticles are bonded to semiconductor macroparticles. The dye(s) are sorbed (e.g., chemisorbed and/or physisorbed) on the semiconductor material. Macroparticles refers to a collection of particles having an average particle size of at least about 100 nanometers (e.g., at least about 150 nanometers, at least about 200 nanometers, at least about 250 nanometers). Examples of photovoltaic cells including macroparticles in the photoactive layer are disclosed in co-pending and commonly owned U.S. Ser. No. 11/179,976, which is hereby incorporated by reference.

In certain embodiments, a DSSC can include a coating that can enhance the adhesion of a photovoltaic material to a base material (e.g., using relatively low process temperatures, such as less than about 300° C.). Such photovoltaic cells and methods are disclosed, for example, in co-pending and commonly owned U.S. Ser. No. 10/351,260, which is hereby incorporated by reference.

The composition and thickness of electrically conductive layer 320 is generally selected based on desired electrical conductivity, optical properties, and/or mechanical properties of the layer. In some embodiments, layer 320 is transparent. Examples of transparent materials suitable for forming such a layer include certain metal oxides, such as indium tin oxide (ITO), tin oxide, and a fluorine-doped tin oxide. In some embodiments, electrically conductive layer 320 can be formed of a foil (e.g., a titanium foil). Electrically conductive layer 320 can be, for example, between about 100 nm and 500 nm thick (e.g., between about 150 nm and 300 nm thick). In certain embodiments, electrically conductive layer 320 can be opaque (i.e., can transmit less than about 10% of the visible spectrum energy incident thereon). For example, layer 320 can be formed from a continuous layer of an opaque metal, such as copper, aluminum, indium, or gold. In some embodiments, an electrically conductive layer can have an interconnected nanoparticle material formed thereon. Such layers can be, for example, in the form of strips (e.g., having a controlled size and relative spacing, between first and second substrates). Examples of such DSSCs are disclosed in co-pending and commonly owned U.S. Ser. No. 10/351,251, which is hereby incorporated by reference.

In some embodiments, electrically conductive layer 320 can include a discontinuous layer of an electrically conductive material. For example, electrically conductive layer 320 can include an electrically conducting mesh. Suitable mesh materials include metals, such as palladium, titanium, platinum, stainless steels and alloys thereof. In some embodiments, the mesh material includes a metal wire. The electrically conductive mesh material can also include an electrically insulating material that has been coated with an electrically conducting material, such as a metal. The electrically insulating material can include a fiber, such as a textile fiber or monofilament. Examples of fibers include synthetic polymeric fibers (e.g., nylons) and natural fibers (e.g., flax, cotton, wool, and silk). The mesh electrically conductive layer can be flexible to facilitate, for example, formation of the DSSC by a continuous manufacturing process. Photovoltaic cells having mesh electrically conductive layers are disclosed, for example, in co-pending and commonly owned U.S. Ser. Nos. 10/395,823, 10/723,554 and 10/494,560, each of which is hereby incorporated by reference.

The mesh electrically conductive layer may take a wide variety of forms with respect to, for example, wire (or fiber) diameters and mesh densities (i.e., the number of wires (or fibers) per unit area of the mesh). The mesh can be, for example, regular or irregular, with any number of opening shapes. Mesh form factors (e.g., wire diameter and mesh density) can be chosen, for example, based on the conductivity of the wire (or fibers) of the mesh, the desired optical transmissivity, flexibility, and/or mechanical strength. Typically, the mesh electrically conductive layer includes a wire (or fiber) mesh with an average wire (or fiber) diameter in the range from about one micron to about 400 microns, and an average open area between wires (or fibers) in the range from about 60% to about 95%.

Catalyst layer 330 is generally formed of a material that can catalyze a redox reaction in the charge carrier layer positioned below. Examples of materials from which catalyst layer can be formed include platinum and polymers, such as polythiophenes, polypyrroles, polyanilines and their derivatives. Examples of polythiophene derivatives include poly(3,4-ethylenedioxythiophene) (“PEDOT”), poly(3-butylthiophene), poly[3-(4-octylphenyl)thiophene], poly(thieno[3,4-b]thiophene) (“PT34bT”), and poly(thieno[3,4-b]thiophene-co-3,4-ethylenedioxythiophene) (“PT34bT-PEDOT”). Examples of catalyst layers containing one or more polymers are disclosed in co-pending and commonly owned U.S. Ser. Nos. 10/897,268 and 60/637,844, both of which are hereby incorporated by reference.

Substrate 310 can be formed from a mechanically-flexible material (such as a flexible polymer) or a rigid material (such as a glass). A flexible material is a material capable of being bent without damage. Examples of flexible materials include polyethylene naphthalates (PEN), polyethylene terephthalates (PET), polyethyelenes, polypropylenes, polyamides, polymethylmethacrylate, polycarbonate, and/or polyurethanes. Flexible substrates can facilitate continuous manufacturing processes such as web-based coating and lamination. However, rigid substrate materials can also be used, such as those disclosed in co-pending and commonly owned U.S. Ser. No. 10/351,265, which is hereby incorporated by reference.

The thickness of substrate 310 can vary as desired. Typically, substrate thickness and type are selected to provide mechanical support sufficient for the DSSC to withstand the rigors of manufacturing, deployment, and use. Substrate 310 can have a thickness of from about six microns to about 5,000 microns (e.g., from about 6 microns to about 50 microns, from about 50 microns to about 5,000 microns, from about 100 microns to about 1,000 microns).

In embodiments where electrically conductive layer 320 is transparent, substrate 310 is formed from a transparent material. As referred to herein, a transparent material transmits at least about 60% (e.g., at least about 70%, at least about 75%, at least about 80%, or at least about 85%) of incident energy at a wavelength or a range of wavelengths used during operation of the photovoltaic cell. As an example, substrate 310 can be formed from a transparent glass or polymer, such as a silica-based glass or a polymer, such as those listed above. In such embodiments, electrically conductive layer 320 may also be transparent.

Substrate 370 and electrically conductive layer 360 can be the same as described above regarding substrate 310 and electrically conductive layer 320, respectively. For example, substrate 370 can be formed from the same materials and can have the same thickness as substrate 310. In some embodiments however, it may be desirable for substrate 370 to be different from 310 in one or more aspects. For example, where the DSSC is manufactured using a process that places different stresses on the different substrates, it may be desirable for substrate 370 to be more or less mechanically robust than substrate 310. Accordingly, substrate 370 may be formed from a different material, or may have a different thickness than substrate 310. Furthermore, in embodiments where only one substrate is exposed to an illumination source during use, it is not necessary for both substrates and/or electrically conducting layers to be transparent. Accordingly, one of substrates and/or corresponding electrically conducting layer can be opaque.

Generally, charge carrier layer 340 includes a material that facilitates the transfer of electrical charge from a ground potential or a current source to photoactive layer 350. A general class of suitable charge carrier materials include solvent-based liquid electrolytes, polyelectrolytes, polymeric electrolytes, solid electrolytes, n-type and p-type transporting materials (e.g., conducting polymers) and gel electrolytes. Examples of gel electrolytes are disclosed in co-pending and commonly owned U.S. Ser. No. 10/350,912, which is hereby incorporated by reference. Other choices for charge carrier media are possible. For example, the charge carrier layer can include a lithium salt that has the formula LiX, where X is an iodide, bromide, chloride, perchlorate, thiocyanate, trifluoromethyl sulfonate, or hexafluorophosphate.

The charge carrier media typically includes a redox system. Suitable redox systems may include organic and/or inorganic redox systems. Examples of such systems include cerium(III) sulphate/cerium(IV), sodium bromide/bromine, lithium iodide/iodine, Fe²⁺/Fe³⁺, Co²⁺/Co³⁺, and viologens. Furthermore, an electrolyte solution may have the formula MᵢXⱼ, where i and j are greater than or equal to one, where X is an anion, and M is lithium, copper, barium, zinc, nickel, a lanthanide, cobalt, calcium, aluminum, or magnesium. Suitable anions include chloride, perchlorate, thiocyanate, trifluoromethyl sulfonate, and hexafluorophosphate.

In some embodiments, the charge carrier media includes a polymeric electrolyte. For example, the polymeric electrolyte can include poly(vinyl imidazolium halide) and lithium iodide and/or polyvinyl pyridinium salts. In certain embodiments, the charge carrier media can include a solid electrolyte, such as lithium iodide, pyridimum iodide, and/or substituted imidazolium iodide.

The charge carrier media can include various types of polymeric polyelectrolytes. For example, suitable polyelectrolytes can include between about 5% and about 95% (e.g., 5-60%, 5-40%, or 5-20%) by weight of a polymer, e.g., an ion-conducting polymer, and about 5% to about 95% (e.g., about 35-95%, 60-95%, or 80-95%) by weight of a plasticizer, about 0.05 M to about 10 M of a redox electrolyte of organic or inorganic iodides (e.g., about 0.05-2 M, 0.05-1 M, or 0.05-0.5 M), and about 0.01 M to about 1 M (e.g., about 0.05-0.5 M, 0.05-0.2 M, or 0.05-0.1 M) of iodine. The ion-conducting polymer may include, for example, polyethylene oxide (PEO), polyacrylonitrile (PAN), polymethylmethacrylate (PMMA), polyethers, and polyphenols. Examples of suitable plasticizers include ethyl carbonate, propylene carbonate, mixtures of carbonates, organic phosphates, butyrolactone, and dialkylphthalates.

In some embodiments, charge carrier layer 340 can include one or more zwitterionic compounds. Charge carrier layers including one or more zwitterionic compounds are disclosed, for example, in co-pending and commonly owned U.S. Ser. No. 11/000,276, which is hereby incorporated by reference.

A DSSC can be manufactured by a roll-to-roll process, such as those disclosed in co-pending and commonly owned U.S. Ser. No. 11/134,921, which is hereby incorporated by reference.

Polymer Photovoltaic Cells

In certain embodiments, a photovoltaic cell 110 or 120 shown in FIG. 1 is a polymer photovoltaic cell. FIG. 4 shows a polymer photovoltaic cell 400 that includes substrates 410 and 470, electrically conductive layers 420 and 460, a hole blocking layer 430, a photoactive layer 440, and a hole carrier layer 450.

In general, substrate 410 and/or substrate 470 can be as described above with respect to the substrates in a DSSC. Exemplary materials include polyethylene tereplithalate (PET), polyethylene naphthalate (PEN), or a polyimide. An example of a polyimide is a KAPTON® polyimide film (available from E. I. du Pont de Nemours and Co.).

Generally, electrically conductive layer 420 and/or electrically conductive layer 470 can be as described with respect to the electrically conductive layers in a DSSC.

Hole blocking layer 430 is generally formed of a material that, at the thickness used in photovoltaic cell 400, transports electrons to electrically conductive layer 420 and substantially blocks the transport of holes to electrically conductive layer 420. Examples of materials from which layer 430 can be formed include LiF, metal oxides (e.g., zinc oxide, titanium oxide) and combinations thereof. While the thickness of layer 430 can generally be varied as desired, this thickness is typically at least 0.02 micron (e.g., at least about 0.03 micron, at least about 0.04 micron, at least about 0.05 micron) thick and/or at most about 0.5 micron (e.g., at most about 0.4 micron, at most about 0.3 micron, at most about 0.2 micron, at most about 0.1 micron) thick. In some embodiments, this distance is from 0.01 micron to about 0.5 micron. In some embodiments, layer 430 is a thin (e.g., at most about 5 nanometers) LiF layer. Such layers are disclosed, for example, in co-pending and commonly owned U.S. Ser. No. 10/258,708, which is hereby incorporated by reference.

Hole carrier layer 450 is generally formed of a material that, at the thickness used in photovoltaic cell 400, transports holes to electrically conductive layer 460 and substantially blocks the transport of electrons to electrically conductive layer 460. Examples of materials from which layer 450 can be formed include polythiophenes (e.g., PEDOT), polyanilines, polyvinylcarbazoles, polyphenylenes, polyphenylvinylenes, polysilanes, polythienylenevinylenes, polyisothianaphthanenes and combinations thereof. While the thickness of layer 450 can generally be varied as desired, this thickness is typically at least 0.01 micron (e.g., at least about 0.05 micron, at least about 0.1 micron, at least about 0.2 micron, at least about 0.3 micron, at least about 0.5 micron) and/or at most about five microns (e.g., at most about three microns, at most about two microns, at most about one micron). In some embodiments, this distance is from 0.01 micron to about 0.5 micron.

Photoactive layer 440 generally includes an electron acceptor material and an electron donor material.

Examples of electron acceptor materials include fullerenes, oxadiazoles, carbon nanorods, discotic liquid crystals, inorganic nanoparticles (e.g., nanoparticles formed of zinc oxide, tungsten oxide, indium phosphide, cadmium selenide and/or lead sulphide), inorganic nanorods (e.g., nanorods formed of zinc oxide, tungsten oxide, indium phosphide, cadmium selenide and/or lead sulphide), or polymers containing moieties capable of accepting electrons or forming stable anions (e.g., polymers containing CN groups, polymers containing CF₃ groups). In some embodiments, the electron acceptor material is a substituted fullerene (e.g., PCBM). In some embodiments, a substituted fullerene can include a fullerene, a pendant group (e.g., a cyclic ether such as epoxy, oxetane, or furan) and a linking group that spaces the pendant group apart from the fullerene. The pendant group is generally sufficiently reactive that the substituted fullerene may be reacted with another compound (e.g., another substituted fullerene) to prepare a reaction product. An example of such a substituted fullerene is C61-phenyl-butyric acid glycidol ester, known as PCBG. Photoactive layers including substituted fullerenes are disclosed, for example, in co-pending and commonly owned U.S. Ser. No. 11/141,979, which is hereby incorporated by reference. Combinations of electron acceptor materials can also be used.

Examples of electron donor materials include discotic liquid crystal polymers, polyacetylenes, polyanilines, polyphenylenes, poly(p-phenylene vinylene)s, polythienylvinylenes, polythiophenes, polyporphyrins, porphyrinic macrocycles, polymetallocenes, polyisothianaphthalenes, polyphthalocyanines, and polysilanes. In some embodiments, the electron donor material is poly(3-hexylthiophene) (P3HT). In certain embodiments, photoactive layer 440 can include a combination of electron donor materials.

In some embodiments, photoactive layer 440 includes an oriented electron donor material (e.g., a liquid crystal (LC) material), an electroactive polymeric binder carrier (e.g., a poly(3-hexylthiophene) material), and a plurality of nanocrystals (e.g., oriented nanorods including at least one of ZnO, WO₃, or TiO₂). The liquid crystal (LC) material can be, for example, a discotic nematic LC material, including a plurality of discotic mesogen units. Each unit can include a central group and a plurality of electroactive arms. The central group can include at least one aromatic ring (e.g., an anthracene group). Each electroactive arm can include a plurality of thiophene moieties and a plurality of alkyl moieties. Within the photoactive layer, the units can align in layers and columns. Electroactive arms of units in adjacent columns can interdigitate with one another to facilitate electron transfer between units. Also, the electroactive polymeric carrier can be distributed amongst the LC material to further facilitate electron transfer. The surface of each nanocrystal can include a plurality of electroactive surfactant groups to facilitate electron transfer from the LC material and polymeric carrier to the nanocrystals. Each surfactant group can include a plurality of thiophene groups. Each surfactant group can be bound to the nanocrystal via, for example, a phosphonic end-group. Each surfactant group can also include a plurality of alkyl moieties to enhance solubility of the nanocrystals in the photoactive layer. Examples of photovoltaic cells are disclosed in co-pending and commonly owned U.S. Ser. No. 60/664,336, which is hereby incorporated by reference.

In certain embodiments, the electron donor and electron acceptor materials in photoactive layer 440 can be selected so that the electron donor material, the electron acceptor material and their mixed phases have an average largest grain size of less than 500 nanometers in at least some sections of layer 440. In such embodiments, preparation of layer 440 can include using a dispersion agent (e.g., chlorobenzene) as a solvent for both the electron donor and the electron acceptor. Such photoactive layers are disclosed, for example, in co-pending and commonly owned U.S. Ser. No. 10/258,713, which is hereby incorporated by reference.

Generally, photoactive layer 440 is sufficiently thick to be relatively efficient at absorbing photons impinging thereon to form corresponding electrons and holes, and sufficiently thin to be relatively efficient at transporting the holes and electrons to the electrically conductive layers of the device. In certain embodiments, layer 440 is at least 0.05 micron (e.g., at least about 0.1 micron, at least about 0.2 micron, at least about 0.3 micron) thick and/or at most about one micron (e.g., at most about 0.5 micron, at most about 0.4 micron) thick. In some embodiments, layer 440 is from 0.1 micron to about 0.2 micron thick.

In some embodiments, the transparency of photoactive layer 440 can change as an electric field to which layer 440 is exposed changes. Such photovoltaic cells are disclosed, for example, in co-pending and commonly owned U.S. Ser. No. 10/486,116, which is hereby incorporated by reference.

In some embodiments, photovoltaic cell 400 can further include an additional layer (e.g., formed of a conjugated polymer, such as a doped poly(3-alkylthiophene)) between photoactive layer 440 and electrically conductive layer 420, and/or an additional layer (e.g., formed of a conjugated polymer) between photoactive layer 440 and electrically conductive layer 460. The additional layer(s) can have a band gap (e.g., achieved by appropriate doping) of 1.8 eV. Such photovoltaic cells are disclosed, for example, in U.S. Pat. No. 6,812,399, which is hereby incorporated by reference.

Optionally, photovoltaic cell 400 can further include a thin LiF layer between photoactive layer 440 and electrically conductive layer 460. Such layers are disclosed, for example, in co-pending and commonly owned U.S. Ser. No. 10/258,708, which is hereby incorporated by reference.

In some embodiments, photovoltaic cell 400 can be prepared as follows. Electrically conductive layer 420 is formed upon substrate 410 using conventional techniques. Electrically conductive layer 420 is configured to allow an electrical connection to be made with an external load. Layer 430 is formed upon electrically conductive layer 420 using, for example, a solution coating process (e.g., such as slot coating, spin coating or gravure coating). Photoactive layer 440 is formed upon layer 430 using, for example, a solution coating process. Layer 450 is formed on photoactive layer 440 using, for example, a solution coating process (e.g., such as slot coating, spin coating or gravure coating). Electrically conductive layer 420 is formed upon layer 450 using, for example, a vacuum coating process, such as evaporation or sputtering.

In certain embodiments, preparation of cell 400 can include a heat treatment above the glass transition temperature of the electron donor material for a predetermined treatment time. To increase efficiency, the heat treatment of the photovoltaic cell can be carried out for at least a portion of the treatment time under the influence of an electric field induced by a field voltage applied to the electrically conductive layers of the photovoltaic cell and exceeding the no-load voltage thereof. Such methods are disclosed, for example, in co-pending and commonly owned U.S. Ser. No. 10/509,935, which is hereby incorporated by reference.

Hybrid Cells

In some embodiments, photovoltaic cell 110 or 120 can be a hybrid cell. For example, the photoactive material in such a cell can contain a dye-sensitized nanoparticles (e.g., titania) typically used in a DSSC and an electron donor material (e.g., P3HT) typically used in a polymer photovoltaic cell. Without wishing to bound by theory, it is believed that the electron donor material can replace the multi-component electrolyte used in a DSSC, thereby simplifying the manufacturing process and improving the reproducibility of a photovoltaic cell.

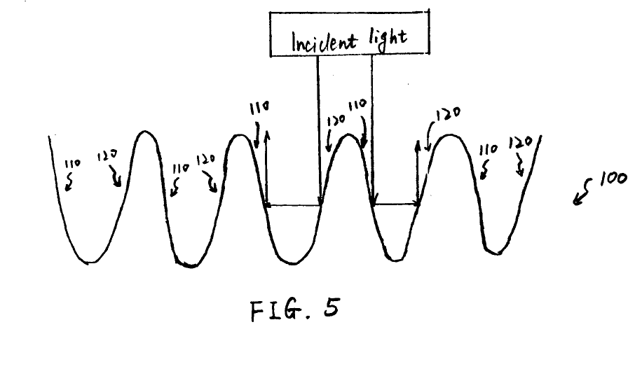

While photovoltaic modules containing V-shaped portions are described, other geometries (e.g., a parabolic shape or a semi-spherical shape) can also be used in a photovoltaic module. FIG. 5 shows a cross-sectional view of a photovoltaic module 100 that includes a plurality of photovoltaic cells 110 and 120, each pair of photovoltaic cells 110 and 120 forming a parabolic shape.

Other embodiments are in the claims.

What is claimed is:

1. A photovoltaic module, comprising:
a first photovoltaic cell having a first photoactive material, the first photoactive material having a first maximum absorption wavelength; and
a second photovoltaic cell having a second photoactive material, the second photoactive material having a second maximum absorption wavelength different from the first maximum absorption wavelength;
wherein the first and second photovoltaic cells are electrically connected and form an angle in the range from about 5° to about 175°.

2. The photovoltaic module of claim 1, wherein the angle is at least about 30°.

3. The photovoltaic module of claim 1, wherein the angle is at most about 60°.

4. The photovoltaic module of claim 1, wherein the first maximum absorption wavelength is at least about 25 nm different from the second maximum absorption wavelength.

5. The photovoltaic module of claim 1, wherein the first photoactive material comprises a first electron acceptor material and the second photoactive material comprises a second electron acceptor material.

6. The photovoltaic module of claim 5, wherein at least one of the first and second electron acceptor materials comprises a material selected from the group consisting of fullerenes, inorganic nanoparticles, oxadiazoles, discotic liquid crystals, carbon nanorods, inorganic nanorods, polymers containing CN groups, polymers containing CF₃ groups, and combinations thereof.

7. The photovoltaic module of claim 6, wherein the at least one of the first and second electron acceptor materials comprises a fullerene.

8. The photovoltaic module of claim 7, wherein the fullerene is a substituted fullerene.

9. The photovoltaic module of claim 5, wherein the at least one of the first and second electron acceptor materials comprises inorganic nanoparticles.

10. The photovoltaic module of claim 9, wherein the inorganic nanoparticles comprise a compound selected from the group consisting of titanium oxide, zirconium oxide, zinc oxide, tungsten oxide, niobium oxide, lanthanum oxide, tin oxide, terbium oxide, tantalum oxide, indium phosphide, cadmium selenide, lead sulphide, and combinations thereof.

11. The photovoltaic module of claim 1, wherein the first photovoltaic cell comprises two electrodes and the second photovoltaic cell comprises two electrodes, at least one of the electrodes comprising ITO, tin oxide, or fluorine-doped tin oxide.

12. The photovoltaic module of claim 1, wherein the photovoltaic module comprises an electrode shared by the first and second photovoltaic cells.

13. The photovoltaic module of claim 1, wherein at least one of the first and second photovoltaic cells comprises a flexible substrate.

14. The photovoltaic module of claim 13, wherein of the flexible substrate comprises a polymer selected from a group consisting of polyethylene naphthalates, polyethylene terephthalates, polyethyelenes, polypropylenes, polyamides, polymethyl methacrylate, polycarbonates, polyurethanes, or combinations thereof.

15. A photovoltaic module, comprising:
a first photovoltaic cell having a first photoactive material, the first photoactive material comprising a first electron acceptor material selected from the group consisting of fullerenes, inorganic nanoparticles, oxadiazoles, discotic liquid crystals, carbon nanorods, inorganic nanorods, polymers containing CN groups, polymers containing CF₃ groups, and combinations thereof; and
a second photovoltaic cell having a second photoactive material;
wherein the first and second photovoltaic cells are electrically connected and form an angle in the range from about 5° to about 175°.

16. The photovoltaic module of claim 15, wherein the angle is at least about 30°.

17. The photovoltaic module of claim 15, wherein the angle is at most about 60°.

18. The photovoltaic module of claim 15, wherein the first electron acceptor material comprises a fullerene.

19. The photovoltaic module of claim 18, wherein the fullerene is a substituted fullerene.

20. The photovoltaic module of claim 18, wherein the first photoactive material further comprises an electron donor material.

21. The photovoltaic module of claim 20, wherein the electron donor material comprises a polymer selected from the group consisting of polyacetylenes, polyanilines, polyphenylenes, poly(p-phenylene vinylene)s, polythienylvinylenes, polythiophenes, polyporphyrins, porphyrinic macrocycles, polymetallocenes, polyisothianaphthalenes, polyphthalocyanines, discotic liquid crystal polymers, and combinations thereof.

22. The photovoltaic module of claim 15, wherein the first electron acceptor material comprises inorganic nanoparticles.

23. The photovoltaic module of claim 22, wherein the inorganic nanoparticles comprise a compound selected from the group consisting of titanium oxide, zirconium oxide, zinc oxide, tungsten oxide, niobium oxide, lanthanum oxide, tin oxide, terbium oxide, tantalum oxide, indium phosphide, cadmium selenide, lead sulphide, and combinations thereof.

24. The photovoltaic module of claim 22, wherein the first photoactive material further comprises a dye.

25. The photovoltaic module of claim 24, wherein the dye comprises a compound selected from the group consisting of cyanines, merocyanines, phthalocyanines, pyrroles and xanthines, and combinations thereof.

26. The photovoltaic module of claim 22, wherein the first photoactive material comprises dye-sensitized interconnected inorganic nanoparticles.

27. The photovoltaic module of claim 15, wherein the first photovoltaic cell comprises two electrodes and the second photovoltaic cell comprises two electrodes, at least one of the electrodes comprising ITO, tin oxide, or fluorine-doped tin oxide.

28. The photovoltaic module of claim 15, wherein the photovoltaic module comprises an electrode shared by the first and second photovoltaic cells.

29. The photovoltaic module of claim 15, wherein at least one of the first and second photovoltaic cells comprises a flexible substrate.

30. The photovoltaic module of claim 29, wherein the flexible substrate comprises a polymer selected from a group consisting of polyethylene naphthalates, polyethylene terephthalates, polyethyelenes, polypropylenes, polyamides, polymethyl methacrylate, polycarbonates, polyurethanes, or combinations thereof.

31. The photovoltaic module of claim 15, wherein the first photoactive material has a first maximum absorption wavelength, and the second photoactive material has a second maximum absorption wavelength at least about 25 nm different from the first maximum absorption wavelength.

32. The photovoltaic module of claim 15, wherein the second photoactive material comprising a second electron acceptor material selected from the group consisting of fullerenes, inorganic nanoparticles, oxadiazoles, discotic liquid crystals, carbon nanorods, inorganic nanorods, polymers containing CN groups, polymers containing CF₃ groups, and combinations thereof.

33. A photovoltaic module, comprising:
a first photovoltaic cell having a flexible substrate; and
a second photovoltaic cell;
wherein the first and second photovoltaic cells are electrically connected and form an angle in the range from about 5° to about 175°.

34. The photovoltaic module of claim 33, wherein the angle is at least about 30°.

35. The photovoltaic module of claim 33, wherein the angle is at most about 60°.

36. The photovoltaic module of claim 33, wherein the flexible substrate comprises a polymer selected from a group consisting of polyethylene naphthalates, polyethylene terephthalates, polyethyelenes, polypropylenes, polyamides, polymethyl methacrylate, polycarbonates, polyurethanes, or combinations thereof.

37. The photovoltaic module of claim 33, wherein the first photoactive material comprises a first electron acceptor material and the second photoactive material comprises a second electron acceptor material.

38. The photovoltaic module of claim 37, wherein at least one of the first and second electron acceptor materials comprises a fullerene.

39. The photovoltaic module of claim 38, wherein the fullerene is a substituted fullerene.

40. The photovoltaic module of claim 37, wherein at least one of the first and second electron acceptor materials comprises inorganic nanoparticles.

41. The photovoltaic module of claim 40, wherein the inorganic nanoparticles comprise a compound selected from the group consisting of titanium oxide, zirconium oxide, zinc oxide, tungsten oxide, niobium oxide, lanthanum oxide, tin oxide, terbium oxide, tantalum oxide, indium phosphide, cadmium selenide, lead sulphide, and combinations thereof.

42. The photovoltaic module of claim 33, wherein the first photovoltaic cell comprises two electrodes and the second photovoltaic cell comprises two electrodes, at least one of the electrodes comprising ITO, tin oxide, or fluorine-doped tin oxide.

43. The photovoltaic module of claim 33, wherein the photovoltaic module comprises an electrode shared by the first and second photovoltaic cells.

44. The photovoltaic module of claim 33, wherein the first photoactive material has a first maximum absorption wavelength, and the second photoactive material has a second maximum absorption wavelength at least about 25 nm different from the first maximum absorption wavelength.

45. A photovoltaic module, comprising
a first photovoltaic cell; and
a second photovoltaic cell;
wherein the first and second photovoltaic cells are electrically connected and form a parabolic shape or a semi-spherical shape.

46. The photovoltaic module of claim 45, wherein the first photovoltaic cell comprising a first photoactive material, and the second photovoltaic cell comprising a second photoactive material identical to the first photoactive material.

47. The photovoltaic module of claim 45, wherein the first photovoltaic cell comprising a first photoactive material having a first maximum absorption wavelength; and the second photovoltaic cell comprising a second photoactive material having a second maximum absorption wavelength, the second maximum absorption length being at least about 25 nm different from the first maximum absorption wavelength.
